(19) United States
(12) Patent Application Publication
(10) Pub. No.: US 2025/0320391 A1
(43) Pub. Date: Oct. 16, 2025

(54) Toughened Two Component Epoxy Structural Adhesive

(71) Applicant: Zephyros, Inc., Romeo, MI (US)

(72) Inventors: Michael Czaplicki, Romeo, MI (US); Yuan Lu, Romeo, MI (US); David Kosal, The Riverwalk (SG)

(21) Appl. No.: 18/868,896

(22) PCT Filed: Jun. 8, 2023
(86) PCT No.: PCT/US2023/024826

§ 371 Date: Nov. 25, 2024

Related U.S. Application Data
(60) Provisional application No. 63/350,079, filed on Jun. 8, 2022.

(51) Int. Cl. C09J 163/00; B32B 7/12; B32B 15/04; B32B 15/08; B32B 15/20; B32B 27/08; C08G 59/18; C08G 59/24; C08G 59/30; C08G 59/46; C08G 59/50; C08G 59/66; C09J 11/08

(52) U.S. Cl. CPC C09J 163/00; B32B 7/12; B32B 15/043; B32B 15/08; B32B 15/20; B32B 27/08; C08G 59/186; C08G 59/245; C08G 59/306; C08G 59/46; C08G 59/50; C08G 59/66; C09J 11/08; B32B 2250/40; B32B 2255/06; B32B 2255/10; B32B 2255/26

(57) ABSTRACT

A two-component room temperature cure adhesive comprising an epoxy resin composition A, and a curative composition B, wherein the curative composition B comprises at least one room temperature curative and at least one chain extender having at least two reactive groups per molecule.

### CLAIM OF PRIORITY

This application claims the benefit of the filing date of U.S. Provisional Application Ser. No. 63/350,079, filed on Jun. 8, 2022. The contents of that application are hereby incorporated by reference herein in their entirety and for all purposes.

### FIELD OF THE INVENTION

The present teachings relate generally to two-component epoxy adhesives that cure at room temperature. The adhesives provide a superior combination of high lap shear strength, T-peel strength, and wedge impact resistance as well as good adhesion on lubricant-contaminated metals.

### BACKGROUND

Epoxy-based adhesives are widely used in industry for both initial assembly structures and repair purposes. One-component adhesives contain latent curatives and are activatable by heat or another stimulus to initiate polymer advancement and subsequent polymerization and/or cross-linking. Curing at elevated temperature (i.e., 150-200° C.) contributes to a crosslinked network and potentially high strength. Heat-induced phase separation of toughening agents (e.g., tougheners) allows for high toughness as indicated by impact or peel resistance or fracture toughness. In addition, heat application can be helpful to improve adhesion to certain contaminated surfaces such as those contaminated with oil or grease where heat may help with displacement or solubilization of contamination. However, one component heat activatable adhesives cannot be used in all applications. For example, light-weight materials (e.g., aluminum, carbon composites) have been widely used in the automotive industry to reduce weight and improve fuel efficiency. Due to differing coefficients of thermal expansion (CTE), these lightweight materials expand and contract differentially with temperature change relative to steel. When materials with different CTE are bonded together by adhesives, distortion of the bonded structure occurs as the adherends experience heating and cooling cycles. The internal stress caused by distortion is known to reduce adhesion durability and poses a challenge for dissimilar material bonding.

In contrast to many heat-activated adhesives, room temperature curable (RTC) adhesives include two components—usually resin component A and curative component B. The curing process starts with the mixing of two components at room temperature. When such adhesives are used to bond dissimilar materials, minimal distortion occurs due to no metal expansion and shrinkage from exposure to temperature change during the bonding process. These adhesives are also better suited to meet the growing interest in low-temperature cure systems (i.e., 100° C. or less) and application settings where heat curing is not possible or convenient, e.g., during automotive body repair. Due to the latency of the curatives in one component heat activatable adhesives, it is difficult or impossible to achieve a suitably high extent of cure at temperatures below 100° C.

Unfortunately, despite the above-mentioned advantages of RTC adhesives, matching the performance of heat-activatable one-component epoxy adhesives has been difficult. In particular, two component-materials often have inferior toughness (e.g., low peel and impact resistance) and often poor adhesion on metals with contamination (e.g., stamping oil) due to higher viscosity and hindered wetting at room temperature.

EP2658939 describes structural adhesive films including combinations of mercaptan and polyamine curing agents. However, the films are formulated to undergo a two-stage cure process, with one stage requiring additional heat to activate the latent curing agent. Thus, room temperature cured formulations having the combination of improved physical characteristics as described herein are neither described nor envisioned.

The present teachings, therefore, seek to provide a room-temperature-cured epoxy adhesive having simultaneous high lap shear strength, improved T-peel strength and impact peel strength, and enhanced adhesion on lubricant-contaminated metal as compared to existing materials two-component adhesives.

### SUMMARY OF INVENTION

The teachings herein are directed to a two-component adhesive comprising an epoxy resin composition A, and a curative composition B, wherein the curative composition B comprises at least one room temperature curative and at least one chain extender having at least two reactive groups per molecule to promote cured adhesives with a structure that more closely emulates thermoplastics. The epoxy resin composition A may contain an epoxy/elastomer adduct and the curative composition B may contain an amine-terminated elastomer.

The epoxy resin composition A and/or the curative composition B may contain a phenol-terminated urethane flexibilizer.

The epoxy resin composition A may contain a diacid adduct.

The adhesive may have a T-peel strength of at least 6 N/mm, when cured at 23° C. for 7 days when determined with 254 mm/min crosshead speed and 0.25 mm bondline.

The adhesive may have a lap shear strength of greater than 20 MPa, when cured at 23° C. for 7 days when determined in accordance with ASTM D5868 with 50.4 mm/min crosshead speed and 0.25 mm bondline.

The adhesive may have a wedge impact peel strength of greater than 21 N/mm when cured at 23° C. for 7 days when determined in accordance with ISO 11343 with 2 m/s test rate and 0.25 mm bondline.

The curative composition B may comprise a difunctional chain extender in the range of about 0.5% to about 30% by weight.

The curative composition B may comprise a multifunctional room temperature curative in the range of about 0.5% to about 90% by weight.

The adhesive may comprise an epoxy/elastomer adduct in the range of about 1% to about 60% by weight of the epoxy resin composition A.

The curative composition B may comprise an amine-terminated elastomer in the range of about 2% to 40%.

The adhesive may include an epoxy/diacid adduct present in an amount of from about 0.2% to about 25% by weight, or even from about 6% to about 10% by weight of the epoxy resin composition A.

The adhesive may comprise a flexibilizer in the range of about 2% to about 50% by weight of the epoxy resin composition A and/or the curative composition B.

The adhesive may include a polymeric particle present in an amount of at least about 3% but less than about 60% by weight, or even at least about 10% but less than about 32% by weight of the epoxy resin composition A.

The adhesive may comprise phenoxy dissolved in an epoxy resin in the range of about 0.5% to about 10% by weight of the epoxy resin composition A.

The adhesive may include a difunctional chain extender selected from mono-primary amines selected from 1-naphthylamine, 2-naphthylamine, ethanolamine, phenethylamine, oleylamine, and dimercaptans such as 2,2′-(ethylenedioxy) diethanethiol and 1,2-ethanedithiol, or any combination thereof. The adhesive may include a room temperature curative selected from an amine, an amine derivative, a polyamide, a mercaptan, or a mercaptan derivative, or any combination thereof.

The elastomer in the epoxy/elastomer adduct may be selected from ATBN, CTBN, ETBN, polysulfide, epoxide terminated siloxane monomers or oligomers or any combination thereof. The adhesive may include an epoxy/diacid adduct wherein the diacid component is selected from a C18 diacid, a C36 diacid, or any combination thereof.

The flexibilizer or flexibilizer in the adduct with epoxy may be selected from, phenol terminated urethane, Epoxonic 328 or any combination thereof.

The polymeric particle may include core modifiers of polybutadiene, styrene-butadiene rubber, or a combination thereof. The polymeric particle may include core/shell rubber particles averaging about 100-200 nm in size. The polymeric particle may be substantially free of agglomerated particles.

The adhesive may include one or more reinforcement components. The adhesive may include one or more reinforcement components selected from silica, diatomaceous earth, glass, clay, nanoclay, glass beads or bubbles, glass, carbon or ceramic fibers, nylon, aramid or polyamide fibers, pyrophyllite, sauconite, saponite, nontronite, wollastonite, montmorillonite, or any combination thereof. The adhesive may include a silica and/or calcium-based reinforcement component. The adhesive may include a silica-based reinforcement component comprising fumed silica.

The adhesive may be substantially free of any component requiring heat for activation. The adhesive may have a sufficient thickness of at least 0.2 mm such that it is thicker than a film adhesive

The adhesive materials described herein provide similar physical properties to heat-cured structural adhesives but are instead provided as two components that are combined and cure at room temperature (e.g., 20° C.-25° C.).

The teachings herein further include a two-component adhesive comprising an epoxy resin composition A, and a curative composition B, wherein the curative composition B comprises at least one room temperature curative selected from an amine, an amine derivative, a polyamide, a mercaptan, or a mercaptan derivative, or any combination thereof, and at least one chain extender having at least two reactive groups per molecule 1-naphthylamine, 2-naphthylamine, ethanolamine, phenethylamine, oleylamine, and dimercaptans such as 2,2′-(ethylenedioxy) diethanethiol and 1,2-ethanedithiol, or any combination thereof.

The teachings herein are also directed to a composite comprising a first material layer comprising an aluminum material or a polymeric material, and a second material layer comprising an aluminum material or a polymeric material, wherein the first material layer is bonded to the second material layer with a two-component adhesive The adhesive comprises an epoxy resin composition A, and a curative composition B, wherein the curative composition B comprises at least one room temperature curative selected from an amine, an amine derivative, a polyamide, a mercaptan, or a mercaptan derivative, or any combination thereof, and at least one chain extender having at least two reactive groups per molecule 1-naphthylamine, 2-naphthylamine, ethanolamine, phenethylamine, oleylamine, and dimercaptans such as 2,2′-(ethylenedioxy) diethanethiol and 1,2-ethanedithiol, or any combination thereof.

The adhesive may include a diacid/epoxy adduct comprising about 1:6 to 6:1 parts of diacid to epoxy and more preferably about 1:4 to 4:1 parts of diacid to epoxy.

The teachings herein also envision a vehicle structure comprising the composites disclosed herein.

The teachings herein are further directed to use of the composites disclosed herein in a transportation vehicle.

The teachings herein are also directed to use of the adhesives described herein to bond two dissimilar materials.

The teachings herein are further directed to use of the adhesives described herein to bond two similar materials.

### BRIEF DESCRIPTION OF THE DRAWINGS

FIG. 1 shows the glass transition temperature (T_{g}) of a of an exemplary material in accordance with the present teachings as determined by dynamic mechanical analysis.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. Percentages herein refer to weight percent, unless otherwise indicated.

The materials of the present teachings may be applied to various articles of manufacture for adding structural integrity to portions or members of the articles. Examples of such articles of manufacture include, without limitation, household or industrial appliances, furniture, storage containers, buildings, structures, or the like. The material may be applied to portions of transportation vehicles including boats, trucks, trains, airplanes, automotive vehicles or the like. The material may be utilized in an automotive vehicle, such as with body or frame members (e.g., a vehicle frame rail) of the automotive vehicle.

The present teachings are directed to an increased plastic nature of the adhesive relative to what has been done in prior art, phase-separating tougheners, and matrix flexibilization for high toughness in a room temperature cured epoxy adhesive.

Reduced crosslinking density may contribute to an increased plastic nature and enhanced local plastic deformation which may facilitate cohesive failure and localized yielding of the adhesive. Cohesive failure occurs when a fracture enables crack propagation through the adhesive, leaving a layer of adhesive on both adherends. In general, it renders improved energy absorption as compared to failure at the interface between adhesive and adherend (adhesive failure). That is why cohesive failure is often associated with high impact resistance, although cohesive failure alone will not achieve that. A material with lower crosslinking density is necessary often to improve strain to failure, especially if the desire is to produce a material that will yield.

One way to introduce the plastic nature is the use of chain extender, a small molecule with two functional groups (e.g., reactive hydrogen) that reacts with epoxy resin to extend the linear chain length of the epoxy resin molecule to help impart thermoplastic-like characteristics. In contrast to a multifunctional curative, chain extenders promote more of a plastic nature, presumable enabling localized relative translation of molecules, and can reduce the internal strength of the adhesive, increasing the likelihood of obtaining cohesive failure of the material. Chain extenders have been found to improve the toughness of a heat activated adhesive when at least 50% of the epoxy resin is chain extended (see U.S. Pat. No. 6,486,256). High extent of chain extension and low degree of crosslinking consequently can reduce the glass transition temperature (T_{g}) of the resulting material. Room temperature cured adhesives have a characteristically low T_{g} in comparison to heat activated materials due to the vitrification effect. As such, use of high doses of chain extender in room temperature cured adhesives may make it difficult to achieve a reasonable T_{g}. Additionally, high doses of chain extenders decelerate the cure of the adhesive because of lower functionality in comparison to common multifunctional curatives. The resulting extended cure time may be problematic for certain applications.

In the present teachings, low percentages of chain extender may be used in combination with other curatives to alter the toughness of the material while maintaining reasonable T_{g} and cure speed. Examples of chain extenders include mono-primary amines, di-secondary amines, and di-mercaptans. As one non-limiting example, mono-primary amines may include 1-naphthylamine, 2-naphthylamine, ethanolamine, phenethylamine, oleylamine, or a combination thereof. Examples of suitable di-mercaptans include DMDO (2,2′-(Ethylenedioxy) diethanethiol) from Arkema Innovative Chemistry, and Thiocure GDMP ((Ethylene glycol bis (3-mercaptopropionate)) from Bruno Bock. The chain extender may be included in an amount of up to about 10% by weight of the curative composition. The curative may be approximately at least about 0.2% by weight, more typically at least about 1% by weight, more typically at least about 2% by weight. The curative may be approximately about 30% or less by weight, more typically about 10% or less by weight, more typically about 7% or less by weight, and even more typically 5% or less by weight of the curative composition.

The epoxy resin composition may additionally include high molecular weight polymers such as phenoxy resin to increase the thermoplastic-like nature of the adhesive. Phenoxy resins are high molecular weight thermoplastic condensation products of bisphenol-A and epichloro-hydrin and their derivatives. The phenoxy resins that may be employed may be of the basic formula:

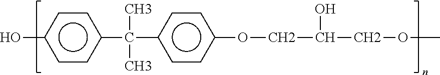

where n is typically from 30 to 100, preferably from 50 to 90. Modified phenoxy resins may also be used. Examples of phenoxy resins that may be used are products marketed by Gabriel Performance Products. Examples of suitable materials are the PKHB, PKHC, PKHH, PKHJ, PKHP pellets and powder. Alternatively, phenoxy/polyester hybrids and epoxy/phenoxy hybrids may be used. In order to enhance the compounding of the adhesive, it is preferred that the phenoxy resin be supplied into the mixed composition as a solution. While any solvent may be used to decrease incorporation temperature during mixing, it is particularly preferred to use a low molecular weight epoxy resin as the solvent as this can be a reactive constituent in the adhesive and improve mechanical properties upon activation.

Phase separating materials can be included in either the epoxy resin composition A or curative composition B depending on the mutual chemical stability of the ingredients. These materials impart flexibility, if partially soluble in the adhesive matrix and increase the ability to absorb energy during plastic deformation. As such, these materials can be included to modify structural properties of the material such as strength, strain-to-failure, fracture toughness (G_{1C}), peel, adhesion durability, stiffness, or other properties.

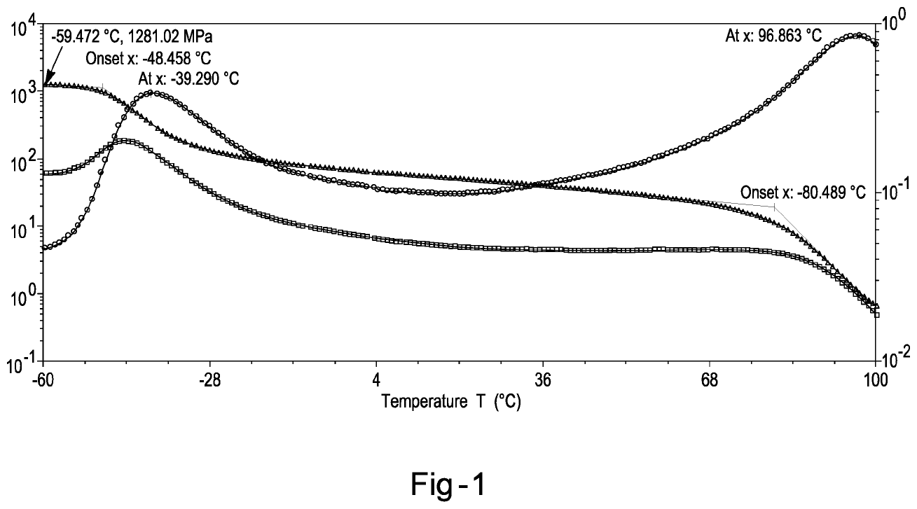

For example, polymercaptan may be included in the curative composition B as a curative and/or chain extender. Polymercaptan curatives not only accelerate the cure but can improve T-peel strength. However, polymercaptans exhibit low compatibility with cured epoxy resin and may phase-separate from the epoxy matrix into distinct domains. When 60% polymercaptan are mixed with 40% epoxy, two distinct glass transition temperatures are observed (i.e., −48.5 and 80.5° C., see FIG. 1). These separated domains are found to promote cohesive failure of the adhesive and consequent high peel strength. With an optimal ratio of polyamide curative to mercaptan curative, T-peel strength of approximately 9 N/mm may be achieved. Examples of di-and multi-functional mercaptans curatives include the Capcure® and Gabepro® products from Gabriel Performance Products and Thiocure® products from Bruno Bock, polysulfides such as Thiokol™ and Thioplast®. It may be included in an amount of up to about 95% by weight of the curative composition B. It may be approximately at least about 2% by weight, more typically at least about 10% by weight, more typically at least about 30% by weight. It may be approximately about 95% or less by weight, more typically about 80% or less by weight, more typically about 75% or less by weight, and even more typically 60% or less by weight of the curative composition B.

The curative composition B may also comprise a phase separating amine-terminated elastomer. Examples of amine-terminated elastomer may be amine-terminated liquid rubber (ATBN) (e.g., Hypro 1300X16 ATBN) from Huntsman Advanced Materials. The amine-terminated elastomer is typically less than 50%, more typically less than 35% and even possibly less than 20% by weight of the curative composition, although higher and lower values may also be possible unless otherwise stated.

Phase separating material may be included in the epoxy resin compositions A as an adduct with epoxy. An example of preferred adducts or preferred components for producing the adduct, is an epoxidized polysulfide polymer such as products sold under the tradenames Thioplast™ G and Thioplast™ EPS. Particularly preferred grades are Thioplast™ G10 and Thioplast™ EPS-80, commercially available from Akzo Nobel. Another example is Hypro™ 1300X13NA (CTBN), commercially available from Emerald Performance Materials®, which can be adducted with the diglycidyl ether of bisphenol-F, diglycidyl ether of bisphenol-A, or any other suitable di-epoxide. Yet another example of a preferred epoxy/elastomer adduct is Hypro™ 1300X63 (ETBN (glycidyl-ester of butadiene and butadiene-acrylonitrile)).

The adduct may be included in an amount of up to about 75% by weight of the epoxy resin composition A. The adduct may be approximately at least about 5% by weight, more typically at least about 20% by weight, more typically at least about 40% by weight. The adduct may be approximately about 75% or less by weight, more typically about 70% or less by weight, more typically about 65% or less by weight, and even more typically 60% or less by weight of the epoxy resin composition. The adduct may be a combination of two or more particular adducts. The adducts may be solid adducts, liquid adducts or semisolids at a temperature of 23° C. or may also be some combination thereof.

Solid adducts may be preferred for physical properties improvement because the higher molecular weight of the adduct has been shown to be capable of enhancing the adhesive performance including peel strength and impact resistance. To incorporate these solid materials into the formulation, a solution with liquid epoxy resin as the solvent may be prepared as a preferred way to reduce mixing temperature.

A flexibilizer may be included in the epoxy resin composition A or curative composition B, depending on the chemical stability of the flexibilizer. The use of the term flexibilizer can relate to a single flexibilizer or a combination of multiple different flexibilizers. Although other flexibilizers may be employed, preferred flexibilizers include polymers that are epoxy modified, urethane-modified prepolymers particularly those that are phenol capped or any combination thereof. It is believed that when a polyurethane flexibilizer is included, the material may exhibit enhanced flexibility, substantially maintain impact strength (e.g., impact resistance) at low temperatures, while minimizing the reduction of glass transition temperature (T_{g}) (e.g., as compared to other flexibilizers). Examples of a preferred flexibilizer may be a phenol-terminated urethane based flexibilizer, Rez-Cure® EP 1820 (available from Innovative Resin Systems), and DY965 from Huntsman.

An example of other preferred flexibilizers are polyurethane modified epoxies sold under the tradenames GME-3210 and GME-3220, commercially available from GNS Technologies. Yet further examples of preferred flexibilizers are epoxy terminated polyethers or amine precursors to produce epoxy terminated polyethers, such as JEFFAMINE M series or SD series, commercially available from Huntsman, DER 732, commercially available from the Olin Corporation. Flexibilizers based on cashew nutshell liquid such as the epoxidized liquids Cardolite NC-514 and Cardolite Lite 2513 HP are also useful flexibilizers. Another example of flexibilizer is Epoxonic 328 adduct. All of the individual flexibilizers discussed herein may be used separately or in combination with each other in the material of the present invention, unless otherwise stated.

Typically, the flexibilizer is less than 50%, more typically less than 35% and even possibly less than 20% by weight, although higher and lower values may also be possible unless otherwise stated.

The epoxy resin composition A may include an epoxy/diacid adduct. The use of the term diacid can relate to any polyfunctional molecule having two carboxylic acid moieties. Some diacid compounds are introduced to an epoxy backbone to reduce strength or stiffness of the adhesive, improve flexibility and adhesion durability after exposure to humidity and corrosion promoted by salt solutions due to hydrophobicity of the adduct. The diacid component of the epoxy/diacid adduct may be C8-C40 or more, diacid compound that is adducted with an epoxy. The epoxy component of the epoxy/diacid adduct may be DGEBF (diglycidyl ether of bisphenol F) and DGEBA (diglycidyl ether of bisphenol A). The diacids may be saturated or unsaturated. Preferably, the diacid is derived from an unsaturated fatty acid. An example of a preferred epoxy/diacid adduct is the product of the esterification of Epotec® YDF-172LV (DGEBF) and a C18 diacid. Other examples of a preferred epoxy/diacid adduct are HyPox® DA323 (DGEBA and dimer fatty acid adduct) available from Emerald Performance Materials® and Epokukdo YD-172 by Kukdo Chemical Co., Ltd.

The adduct generally includes about 1:6 to 6:1 parts of diacid to epoxy and more preferably about 1:4 to 4:1 parts of diacid to epoxy. More typically, the adduct includes at least about 10%, more typically at least about 20% and even more typically at least about 40% diacid and typically includes not greater than about 60%, although higher or lower percentages are possible.

Generally, it is preferable for the epoxy resin composition to include at least one type of polymeric particle. Such polymeric particles may be utilized to improve fracture toughness (G_{1C}), peel resistance and impact resistance. As used herein, the term “polymeric particle” is defined as a particle comprising a polymeric material. Like with any other ingredients of the present teachings, the term “polymeric particle” can include one or more polymeric particles. Various polymeric particles may be employed in the practice of the present teachings and often include one or more elastomers. It is generally preferable for the polymeric particles to be at least 4%, more typically at least 7%, even more typically at least 10%, still more typically at least 13% and even still more typically at least 16% by weight of the activatable material and also preferable for the polymeric particle to be less than 90%, more typically less than 40% an even more typically less than 30% by weight of the activatable material, although higher or lower amounts may be used in particular embodiments.

Examples of useful polymeric particles include but are not limited to particles suspended in liquid epoxy resins sold under the tradename, Kane Ace™, commercially available from Kaneka Americas Holding, Inc. Particularly preferred grades of Kane Ace™ are sold under the designations MX-134 and MX-267. The polymeric particles may average no less than 50 nm and no greater than 300 nm in size.

The curative composition B may comprise at least one polyamine and polyamide curative (e.g., Ancamine® and Ancamide® from Evonik Industries). Certain curatives intended to impart flexibility like Ancamide 910 also improve toughness of the adhesive. The polyamide curative may be included in an amount of up to about 95% by weight of the curative composition B. It may be approximately at least about 30% by weight, more typically at least about 40% by weight, more typically at least about 50% by weight. It may be approximately about 95% or less by weight, more typically about 80% or less by weight, more typically about 75% or less by weight, and even more typically 60% or less by weight of the curative composition B.

The epoxy resin composition described herein may include one or more epoxy resins. Epoxy resins may be added to increase the adhesion, optimize the rheological behavior, and/or provide strength to the material. One exemplary epoxy resin may be a phenolic resin, which may be a novolac type or other type resin. One example of a suitable epoxy resins is Epotec® YDF 172LV (DGEBF), available from Aditya Birla. Other preferred epoxy-containing materials may include modified epoxy resins. The epoxy resins may be silane modified epoxy resins or silane free epoxy resins. For example, a silane modified epoxy resin may aid in allowing the material to adhere to nonferrous metal, such as to aluminum. The silane modified epoxy resin may be a reaction product between at least one epoxy resin and a silane compound. An example of a suitable silane-modified epoxy resin is Epokukdo KSR-177 (di-functional silane-modified epoxy resin) available from Kukdo Chemical. Moreover, various mixtures of several different epoxy resins may be employed as well. Epoxy resins may be present in other formulation constituents such as the epoxy/elastomer adduct, the polymeric particle dispersion, and epoxy/diacid adducts. The concentrations and type of epoxy resins present in the formulation components vary by manufacturer and the particular grade. The epoxy resins may be present in the formulation components as adducts, unreacted epoxy, or both.

The epoxy resin composition A and the curative composition B may include fillers. Fillers can be organic or non-organic additives which differ from the polymeric matrix to improve adhesive properties, change thixotropic properties, and/or improve moisture resistance. These include silicates such as those sold under the trade names of Garamite® and Satintone® clays, mica, talc, clays, wollastonite under the trade names of Nyglos®, Vansil® and Wollastocoat®, calcium carbonate, calcium oxide, calcium sulfate, fumed silica under trade names of Aerosil® and Cab-o-sil®, hollow glass and polymer spheres, carbon black, and graphite. Other additives, agents or performance modifiers may also be included in the material as desired, including but not limited to a UV resistant agent, a flame retardant, a heat stabilizer, a colorant, a processing aid, a lubricant or the like.

It is possible that the specific combination and relative amounts of one or more materials described herein may assist in providing improved values for one or more of T-peel strength, wedge impact peel strength, and/or lap shear strength. As an example, combination of the polyamide and polymercaptan curatives can provide high T-peel strength. With a suitable ratio of polyamide and mercaptan curative, T-peel strength of approximately 9 N/mm may be achieved. The ratio of mercaptan and polyamide can be chosen based on the desired mechanical properties and the cure time for a target application. As another example, the combination of elastomer adduct, flexibilizer, and diacid adduct in the epoxy resin composition A may assist in achieving high impact peel strength. Synergistic effects of these ingredients can be explained by the combination of phase separation toughening, matrix flexibilization, local plastic deformation, and internal strength reduction. For instance, diacid adducts have been found to reduce the strength of the adhesive, facilitating cohesive failure and improved mechanical properties. Elastomer adducts can form phase separating domains for toughening while flexibilizers improve the flexibility of the adhesive matrix.

Certain adhesive materials formed in accordance with the present teachings have exhibited tensile modulus greater than about 900 MPa, greater than about 1200 MPa, and even possibly greater than about 3000 MPa when determined in accordance with ASTM D638 Type IV test method with 5 mm/min crosshead speed.

Certain adhesive materials formed in accordance with the present teachings have exhibited lap shear strength greater than about 10 MPa, greater than about 15 MPa, and even possibly greater than 20 MPa when determined in accordance with ASTM D5868 with 50.4 mm/min crosshead speed and 0.25 mm bondline.

Certain activatable materials formed in accordance with the present teachings have exhibited wedge impact peel strength greater than about 20 N/mm, greater than about 25 N/mm, and even possibly greater than 30 N/mm when determined in accordance with ISO 11343 with 2 m/s test rate and 0.25 mm bondline.

Certain activatable materials formed in accordance with the present teachings have exhibited T-peel strength greater than about 5 N/mm, greater than about 7 N/mm, and even possibly greater than 8.5 N/mm when determined with 254 mm/min crosshead speed and 0.25 mm bondline.

Certain activatable materials formed in accordance with the present teachings have exhibited strain to failure greater than about 5%, greater than about 10%, greater than 20%, and even possibly greater than 30%. The strain to failure was measured by performing a tensile test while using an extensometer to record the deformation that is then used to calculate the material strain.

Certain adhesive materials formed in accordance with the present teachings have exhibited glass transition (T_{g}) of greater than 30 degrees Celsius, greater than 35 degrees Celsius, and even greater than 45 degrees Celsius when determined by ASTM D7028-07. The glass transition temperature determined by this test method (referred to as Dynamic Mechanical Analysis T_{g} or “DMA T_{g}”) may not be the same as that reported by other measurement techniques (i.e., peak of tan delta) on the same test specimen. The test method is commonly used to determine upper use temperature for composite materials.

As one specific example, FIG. 1 shows the glass transition temperature (T_{g}) of a material including 60% polymercaptan and 40% bis A epoxy resin as determined by dynamic mechanical analysis.

For exemplary purposes, Table A is produced below to illustrate four exemplary formulations for forming the room temperature cure adhesives.

TABLE A

| | | | | |
|---|---|---|---|---|
| | Sam- | Sam- | Sam- | Sam- |
| Ingredient (%) | ple 1 | ple 2 | ple 3 | ple 4 |

Part A

| | | | | |
|---|---|---|---|---|
| CTBN Adduct | | 8.80 | | |
| High aspect ratio wollastonite | 3.75 | | 21.00 | 21.00 |
| Diacid Adduct | 7.49 | 6.18 | | |
| Phenoxy Resin | | 1.66 | 1.64 | 1.64 |
| Polymeric Particle | 12.77 | 10.53 | 10.38 | 10.38 |
| Silane Modified Epoxy | 15.67 | 12.92 | 12.74 | 12.74 |
| Bisphenol F Epoxy | 54.61 | 39.33 | 49.57 | 49.57 |
| Urethane Based Flexibilizer | | 5.60 | | |
| Polysulfide Adduct | | 10.30 | | |
| Epoxonic 328 Adduct | 5.56 | 4.58 | 4.51 | 4.51 |
| Pigment | 0.15 | 0.10 | 0.16 | 0.16 |
| Total | 100 | 100 | 100 | 100 |

Part B

| | | | | |
|---|---|---|---|---|
| Polyamide Curing Agent 1 | 22.30 | 32.75 | 18.28 | 13.57 |
| Polyamide Curing Agent 2 | | 25.64 | 7.75 | 8.09 |
| Mercaptan Curing Agent | 12.90 | | 12.67 | 20.75 |
| Chain Extender | 2.20 | 2.44 | 2.05 | 3.14 |
| Amine Terminated Elastomer | 5.76 | | 7.03 | 7.34 |
| Urethane Based Flexibilizer | 6.82 | | 5.43 | 5.67 |
| Polysulfide | 12.53 | | 9.94 | 10.37 |
| Silica | 1.25 | 1.95 | | |
| High aspect ratio wollastonite | 36.33 | 37.12 | 36.69 | 31.92 |
| Pigment | 0.09 | 0.10 | 0.15 | 0.16 |
| Total | 100 | 100 | 100 | 100 |

Properties

| | | | | |
|---|---|---|---|---|
| Part A:Part B Mix ratio by volume | 1:1 | 2:1 | 1:1 | 1:1 |
| Lap shear strength (MPa)* | 21.3 | 20.6 | 21.4 | 21.9 |
| Lap shear testing cohesive failure | 70 | 70 | 90 | 70 |
| (%) | | | | |
| T-peel (N/mm)** | 7.1 | 6.4 | 7.5 | 8.9 |
| T-peel testing cohesive failure (%) | 90 | 0 | 95 | 87 |
| Peak stress (MPa) | 19.9 | 19.2 | 22.4 | 16.0 |
| Modulus (MPa) | 1867 | 1386 | 2567 | 1036 |
| Elongation (%) | 21.1 | 10.8 | 11.8 | 32.2 |
| Wedge impact @ 23° C. - | 5.6 | 10.5 | 5.6 | 7.2 |
| Energy (J)*** | | | | |
| Wedge impact @ 23° C. - | 21.6 | 32.8 | 21.1 | 26.4 |
| Average peel load (N/mm)*** | | | | |
| Tg (° C.) ^{†} | 46 | 49 | 43.2 | 38 |

*0.030″ EG60, test speed: 254 mm/min, bondline 0.25 mm;
**0.060″ EG60, test speed: 50.4 mm/min, bondline 0.25 mm;
***0.030″ EG60, test speed: 2 m/s, drop weight 25 kg, bondline 0.25 mm;
^{†} ASTM D7028-07.
Cure schedule: 7 d at 23° C.

Adhesives shown in Table A are room temperature cure adhesives characterized by high toughness. While maintaining lap shear strength above 20 MPa, T-peel strength of these adhesives is above 6 N/mm, and wedge impact peel strength is above 20 N/mm. Sample 2 which contains no mercaptan curatives shows a T-peel strength above 6 N/mm and a wedge impact peel strength above 30 N/mm. Sample 4 shows a T-peel strength of 8.9 N/mm, superior to some heat-activated adhesives. These results demonstrate that ingredient combinations in the present teachings yield toughened room-temperature cure adhesives with high impact and peel resistance.

The comparative examples shown below demonstrate the change in physical properties based upon the inclusion/removal of certain components in the curative side of the material disclosed herein. Of note, when certain curative is reduced or excluded, the amount of other curatives is adjusted to keep the same stoichiometric ratio.

TABLE B

| Ingredient (%) | Sample 1 | Sample 5 | Sample 6 | Sample 7 | Sample 8 |
|---|---|---|---|---|---|
| Description of change | Control | No chain | Reduced | More | No |
| | | extender | chain | chain | mercaptans |
| | | | extender | extender | |

Part A

| | | | | | |
|---|---|---|---|---|---|
| High aspect ratio wollastonite | 3 | 3 | 3 | 3 | 3 |
| Diacid Adduct | 6 | 6 | 6 | 6 | 6 |
| Polymeric Particle | 10.23 | 10.23 | 10.23 | 10.23 | 10.23 |
| Silane Modified Epoxy | 12.55 | 12.55 | 12.55 | 12.55 | 12.55 |
| Bisphenol F Epoxy | 43.74 | 43.74 | 43.74 | 43.74 | 43.74 |
| Epoxonic 328 Adduct | 4.45 | 4.45 | 4.45 | 4.45 | 4.45 |
| Pigment | 0.13 | 0.13 | 0.13 | 0.13 | 0.13 |

Part B

| | | | | | |
|---|---|---|---|---|---|
| Polyamide Curing Agent 1 | 17.8 | 29 | 23.5 | 13 | 20.5 |
| Mercaptan Curing Agent | 10.3 | 10.3 | 10.3 | 10.3 | |
| Chain Extender | 1.61 | | 0.8 | 2.4 | 1.61 |
| Amine Terminated Elastomer | 4.6 | 4.6 | 4.6 | 4.6 | 4.6 |
| Urethane Based Flexibilizer | 5.44 | 5.44 | 5.44 | 5.44 | 5.44 |
| Polysulfide | 10 | 10 | 10 | 10 | 10 |
| Silica | 1 | 1 | 1 | 1 | 1 |
| High aspect ratio wollastonite | 29 | 29 | 29 | 29 | 29 |
| Pigment | 0.07 | 0.07 | 0.07 | 0.07 | 0.07 |

Properties

| | | | | | |
|---|---|---|---|---|---|
| Part A:Part B Mix ratio by volume | 1:1 | 1:1 | 1:1 | 1:1 | 1:1 |
| Lap shear strength (MPa)* | 21.3 | 10.2 | 13.2 | 13.1 | 18.7 |
| Lap shear testing cohesive failure (%) | 70 | 5 | 15 | 0 | 40 |
| T-peel (N/mm)** | 7.1 | 4.8 | 5.8 | 6.8 | 5.8 |
| T-peel testing cohesive failure (%) | 90 | 5 | 25 | 30 | 100 |
| Peak stress (MPa) | 19.9 | 29 | 24 | 20.5 | 23.1 |
| Modulus (MPa) | 1867 | 2470 | 2021 | 1850 | 2712 |
| Elongation (%) | 21.1 | 10.0 | 12.9 | 14.7 | 2.2 |
| Wedge impact @ 22° C. - Energy (J)*** | 5.6 | 5.9 | 5.3 | 6.6 | 3.8 |
| Wedge impact @ 22° C. - | 21.6 | 18.7 | 16.6 | 19.5 | 12.5 |
| Average peel load (N/mm)*** | | | | | |
| Tg (° C.) ^{†} | 46 | 57 | 54 | 50 | 60 |

*0.030″ EG60, test speed: 254 mm/min, bondline 0.25 mm;
**0.060″ EG60, test speed: 50.4 mm/min, bondline 0.25 mm;
***0.030″ EG60, test speed: 2 m/s, drop weight 25 kg, bondline 0.25 mm.
Cure schedule: 7 d at 23° C.;
^{†} ASTM D7028-07.

The addition of one or more chain extenders to the curative composition B has been found to be key to improving toughness when the adhesive is cured at room temperature for 7 days. As compared to sample 1, sample 5 and 6 (with no or reduced amount of chain extenders) exhibit large physical property reductions including inferior properties of T-peel strength, impact peel strength, and lap shear strength. On the other hand, an increase in the amount of chain extenders above the control concentration (sample 7) also can cause reduction in the lap shear strength in comparison to sample 1 due to reduced crosslink density. These results indicate an optimal concentration of chain extenders for best overall performance. Additionally, the combination of polyamide curatives and mercaptan has been shown to improve T-peel strength and wedge impact peel strength of the resulting adhesive. As shown in Table B, sample 8 (free of mercaptan) demonstrated reduced T-peel strength and wedge impact peel strength as compared to sample 1.

TABLE C

| | | | | | |
|---|---|---|---|---|---|
| | Sam- | Sam- | Sam- | Sam- | Sam- |
| Ingredient (%) | ple 3 | ple 4 | ple 9 | ple 10 | ple 11 |

| | |
|---|---|
| Description of change | Increased mercaptan/polyamide ratio |
| | → |

Part A

| | | | | | |
|---|---|---|---|---|---|
| High aspect ratio | 13.5 | 13.5 | 13.5 | 13.5 | 13.5 |
| wollastonite | | | | | |
| Phenoxy Resin | 1.06 | 1.06 | 1.06 | 1.06 | 1.06 |
| Polymeric Particle | 6.67 | 6.67 | 6.67 | 6.67 | 6.67 |
| Silane Modified Epoxy | 8.19 | 8.19 | 8.19 | 8.19 | 8.19 |
| Bisphenol F Epoxy | 31.86 | 31.86 | 31.86 | 31.86 | 31.86 |
| Epoxonic 328 Adduct | 2.9 | 2.9 | 2.9 | 2.9 | 2.9 |
| Pigment | 0.1 | 0.1 | 0.1 | 0.1 | 0.1 |

Part B

| | | | | | |
|---|---|---|---|---|---|
| Polyamide Curing Agent 1 | 11.96 | 8.5 | 5 | 3 | |
| Polyamide Curing Agent 2 | 5.07 | 5.07 | 5.07 | 5.07 | 5.07 |
| Mercaptan Curing Agent | 8.29 | 13 | 20 | 27 | 49 |
| Chain Extender | 1.34 | 1.34 | 1.34 | 1.34 | 1.34 |
| Amine Terminated | 4.6 | 4.6 | 4.6 | 4.6 | 4.6 |
| Elastomer | | | | | |
| Urethane Based Flexibilizer | 3.55 | 3.55 | 3.55 | 3.55 | 3.55 |
| Polysulfide | 6.5 | 6.5 | 6.5 | 6.5 | 6.5 |
| High aspect ratio | 20 | 20 | 20 | 20 | 20 |
| wollastonite | | | | | |
| Pigment | 0.1 | 0.1 | 0.1 | 0.1 | 0.1 |

Properties

| | | | | | |
|---|---|---|---|---|---|
| Part A:Part B Mix ratio by | 1:1 | 1:1 | 1:1 | 1:1 | 1:1 |
| volume | | | | | |
| Lap shear strength (MPa)* | 21.4 | 21.9 | 14.6 | 11.0 | 7.1 |
| Lap shear testing cohesive | 90 | 70 | 35 | 0 | 0 |
| failure (%) | | | | | |
| T-peel (N/mm)** | 7.5 | 8.9 | 8.7 | 7.0 | 7.7 |
| T-peel testing cohesive | 95 | 87 | 90 | 70 | 17 |
| failure (%) | | | | | |
| Wedge impact @ 22° C. - | 5.6 | 7.2 | 6.4 | 6.1 | 7.1 |
| Energy (J)*** | | | | | |
| Wedge impact @ 22° C. - | 21.1 | 26.4 | 23.7 | 23.6 | 17.3 |
| Average peel load | | | | | |
| (N/mm)*** | | | | | |
| Open time (10 g/3 mm) min | 45 | 14 | 10 | 7 | 3.5 |
| Fixture time (0.5 inch | 180 | 120 | 80 | 25 | 7.5 |
| overlap, 1 kg weight) min | | | | | |

*0.030″ EG60, test speed: 254 mm/min, bondline 0.25 mm;
**0.060″ EG60, test speed: 50.4 mm/min, bondline 0.25 mm;
***0.030″ EG60, test speed: 2 m/s, drop weight 25 kg, bondline 0.25 mm;
****0.3 MPa lap shear strength.
Cure schedule: 7 d at 23° C.

The ratio of polyamide and mercaptan curing agents plays an important role in determining the adhesive physical properties, especially lap shear, peel and impact resistance. Since polyamide curing agent 2 is known to improve adhesive toughness, to demonstrate how mercaptans affect the peel and impact resistance, polyamide curing agent 2 is kept constant in all samples. As shown in Table C, samples 3,4, and 9-11 contain different percentages of mercaptan. As the mercaptan percentage increases, physical properties including lap shear strength, T peel strength and impact peel strength increase first and then decline. For example, sample 4 with approximately 20% mercaptan in the curative composition demonstrates highest lap shear strength (i.e., 21.9 MPa), T peel strength (i.e., 8.9 N/mm) and wedge impact peel resistance (i.e., 26.4 N/mm). Further increase in mercaptan leads to reduction in these properties. For sample 11 with 49% mercaptan in the curative composition B, lap shear strength and impact peel strength decreased to 7.1 MPa and 17.3 N/mm, respectively. The present teachings demonstrate that polymercaptan can be used not only to accelerate the cure speed but to improve the adhesive properties in combination with polyamide and chain extender. Ratio of mercaptan and polyamide can be chosen based on target mechanical properties and cure time. Increasing percentage of mercaptan did, however, continue to decrease both open time and fixture time, as would be expected.

TABLE D

| | Sample | Sample | Sample | Sample | Sample | Sample | Sample | Sample |
|---|---|---|---|---|---|---|---|---|
| | 2 | 12 | 13 | 14 | 15 | 16 | 17 | 18 |
| | Description of change | | | | | | | |
| | | | | | | | | No |
| | | No | No | No | No | No | No | silane |
| | | urethane | CTBN | polysulfide | Epoxonic | diacid | phenoxy | modified |
| Ingredient (%) | control | flexibilizer | adduct | adduct | adduct | adduct | resin | epoxy |

Part A

| | | | | | | | | |
|---|---|---|---|---|---|---|---|---|
| CTBN Adduct | 8.55 | 8.55 | | 8.55 | 8.55 | 8.55 | 8.55 | 8.55 |
| Diacid Adduct | 6 | 6 | 6 | 6 | 6 | | 6 | 6 |
| Phenoxy | 1.62 | 1.62 | 1.62 | 1.62 | 1.62 | 1.62 | | 1.62 |
| Resin | | | | | | | | |
| Polymeric | 10.23 | 10.23 | 10.23 | 10.23 | 10.23 | 10.23 | 10.23 | 10.23 |
| Particle | | | | | | | | |
| Silane | 12.55 | 12.55 | 12.55 | 12.55 | 12.55 | 12.55 | 12.55 | |
| Modified | | | | | | | | |
| Epoxy | | | | | | | | |
| Bisphenol F | 38.17 | 38.17 | 38.17 | 38.17 | 38.17 | 38.17 | 38.17 | 38.17 |
| Epoxy | | | | | | | | |
| Urethane | 5.44 | | 5.44 | 5.44 | 5.44 | 5.44 | 5.44 | 5.44 |
| Based | | | | | | | | |
| Flexibilizer | | | | | | | | |
| Polysulfide | 10 | 10 | 10 | | 10 | 10 | 10 | 10 |
| Adduct | | | | | | | | |
| Epoxonic 328 | 4.45 | 4.45 | 4.45 | 4.45 | | 4.45 | 4.45 | 4.45 |
| Adduct | | | | | | | | |

Part B

| | | | | | | | | |
|---|---|---|---|---|---|---|---|---|
| Polyamide | 16.76 | 23.26 | 12.7 | 25.81 | 19.81 | 20.3 | 15.35 | 11.42 |
| Curing Agent | | | | | | | | |
| 1 | | | | | | | | |
| Polyamide | 13.12 | 18.21 | 9.94 | 20.21 | 15.51 | 15.87 | 12.01 | 8.946 |
| Curing Agent | | | | | | | | |
| 2 | | | | | | | | |
| Chain | 1.25 | 1.74 | 0.945 | 1.925 | 1.477 | 1.515 | 1.146 | 0.851 |
| Extender | | | | | | | | |
| Silica | 1 | 1 | 1 | 1 | 1 | 1 | 1 | 1 |
| High aspect | 19 | 19 | 19 | 19 | 19 | 19 | 19 | 19 |
| ratio | | | | | | | | |
| wollastonite | | | | | | | | |
| Pigment | 0.05 | 0.05 | 0.05 | 0.05 | 0.05 | 0.05 | 0.05 | 0.05 |

Properties

| | | | | | | | | |
|---|---|---|---|---|---|---|---|---|
| Part A:Part B | 2:1 | 2:1 | 2:1 | 2:1 | 2:1 | 2:1 | 2:1 | 2:1 |
| Mix ratio by | | | | | | | | |
| volume | | | | | | | | |
| Lap shear | 20.6 | 11.2 | 14.7 | 16.7 | 19.7 | 17.1 | 15.8 | 12.1 |
| strength | | | | | | | | |
| (MPa)* | | | | | | | | |
| Lap shear | 70 | 0 | 0 | 0 | 30 | 0 | 0 | 0 |
| testing | | | | | | | | |
| cohesive | | | | | | | | |
| failure (%) | | | | | | | | |
| T-peel | 6.4 | 4.6 | 5.4 | 4.1 | 5.5 | 5.3 | 4.6 | 5.1 |
| (N/mm)** | | | | | | | | |
| T-peel testing | 0 | 0 | 20 | 0 | 0 | 0 | 15 | 0 |
| cohesive | | | | | | | | |
| failure (%) | | | | | | | | |
| Peak stress | 19.2 | 24.4 | 15.3 | 24.2 | 21.2 | 19.8 | 20.7 | 21.1 |
| (MPa) | | | | | | | | |
| Modulus | 1386 | 1671 | 1452 | 1683 | 1677 | 1442 | 1737 | 1722 |
| (MPa) | | | | | | | | |
| Elongation | 10.8 | 23.1 | 2.8 | 31.2 | 15.7 | 20.7 | 16.0 | 18.7 |
| (%) | | | | | | | | |
| Wedge impact | 10.5 | 4.0 | 2.6 | 6.5 | 4.2 | 6.4 | 5.9 | 6.2 |
| @ 23° C. - | | | | | | | | |
| Energy (J)*** | | | | | | | | |
| Wedge impact | 32.8 | 13.8 | 9.5 | 18.8 | 14.1 | 19.4 | 18.7 | 18.8 |
| @ 23° C. - | | | | | | | | |
| Average peel | | | | | | | | |
| load | | | | | | | | |
| (N/mm)*** | | | | | | | | |
| Tg (° C.) ^{†} | 49 | 57 | 50 | 56 | 57 | 55 | 54 | 55 |

*0.030” EG60, test speed: 254 mm/min, bondline 0.25 mm;
**0.060” EG60, test speed: 50.4 mm/min, bondline 0.25 mm;
***0.030” EG60, test speed: 2 m/s, drop weight 25 kg, bondline 0.25 mm; ^{†} ASTM D7028-07. Cure schedule: 7 d at 23° C.

Combination of elastomer adduct, flexibilizer, thermoplastic, and diacid adduct is critical to achieve superior adhesive performance, especially impact resistance. Table D shows how exclusion of these ingredients affects the mechanical properties of the resulting adhesives. Sample 2 includes all components and demonstrates the best overall performance and the greatest wedge impact peel strength and energy. Sample 13 excludes CTBN adduct and shows reduced lap shear strength, T peel strength, wedge impact peel strength, and energy. Sample 14 and 12 are free of polysulfide adduct and urethane flexibilizer, respectively. Both demonstrate reduced lap shear strength, T peel strength, wedge impact peel strength and energy. Sample 15 and 17, which are free of Epoxonic adduct flexibilizer and phenoxy resin showed reduced T peel strength and impact peel strength. Sample 16 is free of diacid adduct and demonstrates lower T peel strength, wedge impact peel strength and energy. This result demonstrates the synergistic effect of these ingredients on adhesive physical properties.

TABLE E

| | | | Scotch | |
|---|---|---|---|---|
| | | | Weld DP420 | Sikapower |
| | Sample 2 | Fusor 2098 | Black | 1277 |
| Manufacture | L&L | Dow and | 3M | Sika |
| | | Lord | | |
| Lap shear | 9.8 | 0.9 | 0 | 6.0 |
| strength* (MPa) | | | | |

*0.060″ EG60, 0.39-0.46 mg/cm² lubricant FERROCOTE ® 61 MAL HCL, test speed: 50.4 mm/min, bondline 0.25 mm

Certain adhesive materials formed in accordance with the present teachings have exhibited improved adhesion on lubricant contaminated metal. In comparison to three commercial competitive products, sample 2 showed much higher lap shear strength on 0.39-0.46 mg/cm² Ferrocote 61 MAL. HCl coated EG60. This result suggests that adhesives in the present teaching may allow for no or minimal cleaning of the metal adherent which can provide significant advantage in manufacturing facilities. Besides, in the event of insufficient metal cleaning, the adhesive in this invention may ensure improved bonding strength compared to the competitive products.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80,more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A two-component adhesive comprising:
i) an epoxy resin composition A; and
ii) a curative composition B, wherein the curative composition B comprises:
a) at least one room temperature curative;
b) at least one chain extender having at least two reactive groups per molecule;
wherein the epoxy resin composition A contains an epoxy/elastomer adduct and the curative composition B contains an amine-terminated or mercaptan-terminated elastomer.

2. The adhesive of claim 1, wherein the epoxy resin composition A or/and the curative composition B contains a phenol-terminated urethane flexibilizer.

3. The adhesive of claim 1, where the epoxy resin composition A contains a diacid adduct.

4. The adhesive of claim 1, wherein the adhesive has a T-peel strength of at least 6 N/mm, when cured at 23° C. for 7 days when determined with 254 mm/min crosshead speed and 0.25 mm bondline.

5. The adhesive of claim 1, wherein the adhesive has a lap shear strength of greater than 20 MPa, when cured at 23° C. for 7 days when determined in accordance with ASTM D5868 with 50.4 mm/min crosshead speed and 0.25 mm bondline.

6. The adhesive of claim 1, wherein the adhesive has a wedge impact peel strength of greater than 21 N/mm, when cured at 23° C. for 7 days when determined in accordance with ISO 11343 with 2 m/s test rate and 0.25 mm bondline.

7. The adhesive of claim 4, wherein the curative composition B comprises a difunctional chain extender in the range of about 0.5% to about 30% by weight.

8. The adhesive of claim 4, wherein the curative composition B comprises a multifunctional room temperature curative in the range of about 0.5% to about 90% by weight.

9. The adhesive of claim 4, wherein the adhesive comprises an epoxy/elastomer adduct in the range of about 1% to about 60% by weight of the epoxy resin composition A.

10. The adhesive of claim 4, wherein the curative composition B comprises an amine-terminated elastomer in the range of about 2% to 40%.

11. The adhesive of claim 10, including an epoxy/diacid adduct present in an amount of from about 0.2% to about 25% by weight, or even from about 6% to about 10% by weight of the epoxy resin composition A.

12. The adhesive of claim 1, wherein the adhesive comprises a flexibilizer in the range of about 2% to about 50% by weight of the epoxy resin composition A and/or the curative composition B.

13. (canceled)

14. The adhesive of claim 1, wherein the adhesive comprises phenoxy dissolved in an epoxy resin in the range of about 0.5% to about 10% by weight of the epoxy resin composition A.

15. The adhesive of claim 1, including a difunctional selected from 1-naphthylamine, 2-naphthylamine, ethanolamine, phenethylamine, oleylamine, and dimercaptans such as 2,2′-(ethylenedioxy) diethanethiol and 1,2-ethanedithiol, or any combination thereof.

16. The adhesive of claim 14, including a room temperature curative selected from an amine, an amine derivative, a polyamide, a mercaptan, or a mercaptan derivative, or any combination thereof.

17-26. (canceled)

27. The adhesive of claim 1, wherein the adhesive is substantially free of any component requiring heat for activation.

28. The adhesive of claim 1, wherein the adhesive has a sufficient thickness of at least 0.2 mm so that it is thicker than a film adhesive.

29. A two-component adhesive comprising:
i) an epoxy resin composition A; and
ii) a curative composition B, wherein the curative composition B comprises:
c) at least one room temperature curative selected from an amine, an amine derivative, a polyamide, a mercaptan, or a mercaptan derivative, or any combination thereof; and
d) at least one chain extender having at least two reactive groups per molecule 1-naphthylamine, 2-naphthylamine, ethanolamine, phenethylamine, oleylamine, and dimercaptans such as 2,2′-(ethylenedioxy) diethanethiol and 1,2-ethanedithiol, or any combination thereof.

30. A composite comprising:
ii) a first material layer comprising an aluminum material or a polymeric material;
iii) a second material layer comprising an aluminum material or a polymeric material, wherein the first material layer is bonded to the second material layer with a two-component adhesive comprising:
a) an epoxy resin composition A; and
b) a curative composition B, wherein the curative composition B comprises:
c) at least one room temperature curative selected from an amine, an amine derivative, a polyamide, a mercaptan, or a mercaptan derivative, or any combination thereof; and
d) at least one chain extender having at least two reactive groups per molecule 1-naphthylamine, 2-naphthylamine, ethanolamine, phenethylamine, oleylamine, and dimercaptans such as 2,2′-(ethylenedioxy) diethanethiol and 1,2-ethanedithiol, or any combination thereof.

31. The adhesive of claim 29, including a diacid/epoxy adduct comprising about 1:6 to 6:1 parts of diacid to epoxy and more preferably about 1:4 to 4:1 parts of diacid to epoxy.

32-35. (canceled)
